(19) United States
(12) Patent Application Publication
(10) Pub. No.: US 2006/0129480 A1
(43) Pub. Date: Jun. 15, 2006

(54) Credit card interest rate exchange and reduction method

(76) Inventor: Harvey P. Tabb, Santa Ana, CA (US)

Correspondence Address: MORLAND C FISCHER, 2030 MAIN ST, SUITE 1050, IRVINE, CA, 92614, US

(21) Appl. No.: 11/009,747

(22) Filed: Dec. 13, 2004

(51) Int. Cl. G06Q 40/00

(52) U.S. Cl. 705/39

(57) ABSTRACT

A credit card interest rate exchange and reduction method to benefit consumers who hold relatively high interest credit card debt and banks looking to invest non-income producing idle or excess cash on hand in the consumer marketplace. An intermediary solicits individual consumers who wish to reduce the interest rates that have been assigned to their existing credit card debt. Such individual consumers are placed into different groups having similar credit histories, and a credit score is assigned to each group. The intermediary locates a lender bank or similar institution that is willing to use its investment capital to pay off some or all of the existing credit card debts of the consumers solicited by the intermediary. The lender bank then refinances the credit card debts of the consumers in each group at a lower interest rate, wherein the new interest rates are dependent upon the credit scores that have been assigned to the respective groups.

### BACKGROUND OF THE INVENTION

1. Field of the Invention

This invention relates to a credit card interest rate exchange and reduction method for the benefit of both consumers who hold relatively high interest credit card debt and banks and similar lending institutions looking to invest excess or idle funds in the consumer marketplace. Individual consumers wishing to reduce the interest rates that have been assigned to their existing credit card debt are grouped together according to their credit histories, and the investment capital of lenders is used to pay off the existing credit card debts which, in turn, are refinanced at lower interest rates that depend upon the credit scores of the respective groups of consumers.

2. Background Art

A large percentage of the population today use credit cards to make daily purchases. The cumulative purchases made by credit card holders during any month is often so high that they are unable to make timely payment of their credit card debt. As a consequence, credit card holders are faced with high interest rates charged by credit card companies until the debt has been fully repaid. Double digit interest rates are common in the unsecured credit card industry, despite the fact that interest rates on secured loans are typically at single digit levels. Credit card companies make no exception in the interest rates charged to their customers who carry credit card debt. That is to say, those consumers who are the best credit risks and to have the highest credit standing will typically be charged the same interest rate as those consumers who are the worst credit risks and to have the lowest credit standing. Because full repayment of credit card debt can often take many months, the high interest rates charged by credit card companies often reduce the disposable incomes of their customers. Although it would be desirable for credit card holders to increase their disposable income by reducing the interest rate paid on their credit card debt, many individual consumers are unable to easily locate or qualify for opportunities by which to refinance their credit card debt at a lower interest rate.

Banks and similar lending institutions are known to spend vast sums of money for print advertising, mass mailing, telemarketing, etc. by which to attract new and return customers. Because of stiff competition in the banking industry, banks are sometimes forced to offer very low and even no interest unsecured loans to their customers. Such high marketing costs and low interest loans often result in the banks recovering minimal returns on their investment in the consumer industry. What is even more, banks are often faced with a sudden inflow of cash which will earn no return unless the cash can be quickly reinvested. In cases where banks wish to enter the consumer marketplace to invest their idle or excess cash on hand, it has often proved difficult to identify and place large amounts of cash with a large number of consumers in a short time. In this same regard, banks are susceptible to lost earnings as a consequence of targeting both high and low credit scoring consumers with blanket interest rates which, overall, prove to be too low to make a positive impact on the banks' bottom line. Although it would be desirable for lender banks to acquire investment portfolios in the consumer marketplace which would increase profitability, many banks are unable to easily locate such portfolios which meet their objectives and consist of individual consumers which fit the bank's investment strategy.

Examples of on-line systems which allow secured loans (e.g., mortgages) to be packaged together and sold to investors depending upon credit scores are available by referring to U.S. Pat. No. 6,223,566 and to U.S. Patent Application Publication No. 2003/0018558.

### SUMMARY OF THE INVENTION

In general terms, a credit card interest rate exchange and reduction method is disclosed herein by which individual consumers wishing to reduce the high interest rates that have been assigned by credit card companies to their existing credit card debt are grouped together according to their credit histories in order to achieve a lower interest rate. In particular, consumers holding credit card debt are placed into groups with other consumers whose credit histories are determined to be similar. By way of example, the FICO scoring system can be used to rank the credit worthiness of consumers in order to determine the groups in which they will be placed. In this case, those consumers having the highest credit scores and the best credit histories will be placed together in the same group, consumers having the lowest credit scores and the worst credit histories will be placed together in the same group, and consumers having intermediate credit scores and intermediate credit histories will be placed together in the same group or groups.

It will be up to an intermediary to locate consumers wishing to refinance their credit card debt at a lower interest rate, to verify the credit histories and scores of these consumers, to place the consumers into appropriate groups depending upon their credit scores, and to locate a bank or similar institutional lender who has idle or excess cash and is looking for a tiered investment portfolio in the consumer marketplace. Provided that the consumers who have been solicited and grouped by the intermediary meet the objectives and strategy of the bank, its investment capital is used to extinguish the existing high interest rate credit card debt of these consumers. The consumers' credit card debt is then refinanced at a lower interest rate which is dependent upon the credit scores of the consumers and the corresponding groups into which they have been placed. Therefore, consumers assigned to the highest groups with the highest credit worthiness will pay the lowest interest rate, while consumers assigned to the lowest groups with the lowest credit worthiness will pay the highest interest rates.

By virtue of the foregoing, groups of individual consumers with similar credit histories will be able to reduce the interest rate on their long term credit and debt. At the same time, lender banks will be offered an attractive investment vehicle which is capable of reaching many consumers so as to enable the bank to achieve a fluid utilization of its funds on hand and a predictable rate of return in order to increase its bottom line profit while avoiding the high cost of advertising and the minimum returns that have been typically associated therewith.

### BRIEF DESCRIPTION OF THE DRAWINGS

FIG. 1 is a table by which to illustrate the credit card interest rate exchange and reduction method of this invention where consumers are grouped according to their credit histories and offered reduced interest rates to refinance their existing credit card debt depending upon the groups to which they are assigned; and

FIG. 2 is a block diagram to show the interrelationship of an intermediary with consumers looking to reduce the interest rate assigned to their existing high interest credit card debt and lender banks wishing to invest cash on hand in the consumer marketplace by means of a tiered investment portfolio as illustrated in FIG. 1.

### DESCRIPTION OF THE PREFERRED EMBODIMENT

The credit card interest rate exchange and reduction method herein disclosed is a service offered to consumers and lender banks, alike. The service described herein is performed by an intermediary who links groups of consumers having credit card debt to banks and similar institutional lenders who are seeking a consumer based investment for their idle, non-income producing cash on hand. In particular, and as will be described herein, consumers holding relatively high interest credit card debt will be able to refinance their debt at a lower interest rate according to their credit standing. Banks, wishing to expand their consumer investment portfolio, will have a vehicle by which to make loans to many different consumers who are grouped together with other consumers having similar credit scores and presenting similar risk factors.

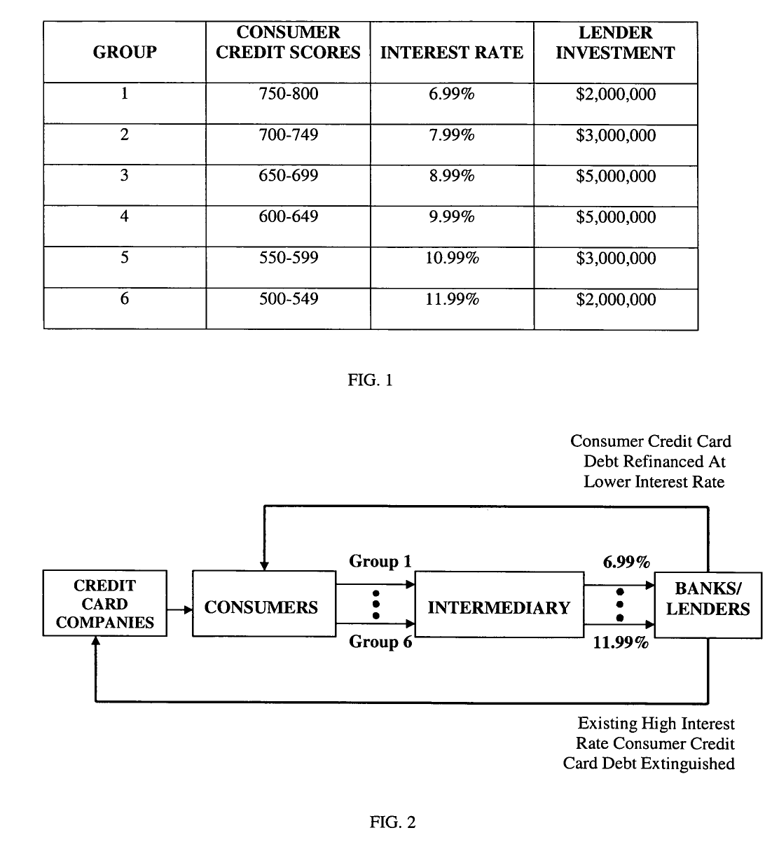

FIG. 1 of the drawings provides a listing of credit scores assigned to consumers according to their credit histories. The credit scores listed in FIG. 1 range from 500 for consumers having the lowest credit worthiness to 800 for consumers having the highest credit worthiness. The credit scores assigned to consumers in FIG. 1 are consistent with the popular FICO scoring system. However, the particular scoring system shown in FIG. 1 is for the purpose of example only, and it is to be understood that any other system of assigning a credit rating or score to consumers based upon their credit history can be employed in the interest rate exchange and reduction method herein disclosed.

As also shown, individual consumers are bundled into different Groups 1-6 of consumers having similar credit scores. By way of example, each group includes consumers having credit scores which span 50 credit scoring points. Therefore, in the example of FIG. 1, those consumers having credit scores lying in a range of scores between 750 and 800 will be bundled together into Group 1 as the highest credit worthy consumers. Those consumers having credit scores lying in range of scores between 500 and 549 will be bundled together into Group 6 as the lowest credit worthy consumers. Consumers having credit scores which lie between 501 and 749 will be bundled together into Groups 2-5 as intermediate credit worthy consumers.

The credit card interest rate exchange and reduction method herein disclosed is intended to offer those consumers having the highest credit scores the ability to exchange relatively high interest rates to which they have been assigned for paying off existing credit card debt with significantly lower interest rates. Consumers who carry credit card debt often experience interest rates up to 21 percent or more until their existing balance is repaid in full. In cases where consumers, such as those falling into the top Groups 1-3 of FIG. 1, have maintained reliable credit histories and regularly make on-time payments, a double digit credit card interest rate may be unjustified. With the prime rate of interest currently at or near a historically low rate, even those consumers falling into the bottom Groups 4-6 hope to find an interest rate below the extremely high rates that are now being charged by some credit card lenders. Being able to locate and qualify for a lower rate of interest credit card debt is not always easy for individual consumers, whereby they require more time to move out of debt.

In this same regard, banks and other lenders are constantly looking to diversify their investment portfolios without first having to spend large sums of money to advertise or offer costly incentives to prospective borrowers. In some cases, a bank (or other institutional lender) may happen to have a large sum of money (e.g., 20 million dollars) on hand due to a sudden and unexpected cash inflow. Leaving such large investment capital sitting idle for any prolonged amount of time could negatively impact the bank's bottom line financial condition. Thus, banks may be actively searching for structured, consumer based investments in which to place available cash so as to improve their bottom line profits. As in many investment strategies, a bank may be willing to take a larger risk for the prospect of a larger rate of return.

Accordingly, the intermediary can provide to a bank or similar lender a structured investment vehicle which benefits both the bank and those consumers who will be linked to the bank in an effort to exchange their relatively high credit card interest rate for a lower rate. Referring once again to FIG. 1, the bank is offered a tiered investment strategy among the consumer Groups 1-6. To this end, the bank may make a business decision to invest its 20 million dollars cash on hand by allocating a portion of the investment to each consumer group. Therefore, and by way of a first example illustrated in FIG. 1, the bank may decide to allocate 2 million dollars to those consumers who are bundled together in Group 1 and have the highest credit scores. This 2 million dollar investment is then used to pay off some or all of the existing credit card debt of some or all of the consumers from Group 1 which has heretofor been carried at a higher interest rate. Because the consumers of Group 1 have the highest credit scores, the lender bank will face the lowest risk of consumer default. In this case, the consumers who are bundled into Group 1 will have their prior credit card debt interest rate exchanged for a relatively low interest rate of, for example, 6.99 percent. Of course, those consumers who have a very low or zero credit card debt interest rate are unlikely to either require the services of the intermediary or find themselves in need of a lender bank for the advantages described above.

By way of a second example, the bank may decide to allocate another 2 million dollars of its 20 million dollar investment to those consumers who are bundled together in Group 6 and have the lowest credit scores. This 2 million dollar investment is used to pay off some or all of the existing credit card debt of some or all of the consumers from Group 6 that typically carry the highest interest rates. Because the consumers from Group 6 have the lowest credit scores, the lender bank will face the highest risk of consumer default. Therefore, the consumers bundled into Group 6 are offered an interest rate of, for example, 11.99 percent which is intended to lower the interest rate at which the Group 6 consumers have paid off their credit card debt in the past. Likewise, only those consumers who will benefit by an interest rate reduction for their credit card debt will be bundled into Group 6 (or in any other Group) and be part of the tiered program that is offered to the bank as part of its consumer investment portfolio.

It will be up to the intermediary to solicit, verify the credit histories of, and group those individual consumers who wish to avail themselves of the intermediary's services of locating banks or other institutions who have money to lend that will be dedicated to paying off the consumers' existing credit card debt which carries a relatively high interest rate to be replaced (i.e., refinanced) by a debt which carries a lower interest rate. For this service, the intermediary will charge its consumer customers a fee. In fact, as part of its service, the intermediary can, on a periodic basis and depending upon changes in interest rates and/or credit scores, analyze and sweep its consumer customers into new groups to be offered to the same or a new bank in an ongoing effort to lower the current interest rate that has been assigned to the credit card debt of customers of the intermediary. The intermediary can also find new, lower interest credit cards as part of the service offered to its customers.

It will also be up to the intermediary to find one or more banks having available investment capital to lend to customers of the intermediary at predetermined tiered interest rates, such as those illustrated in FIG. 1. Hence, the bank will have presented to it an attractive investment vehicle to enable the fluid utilization of its idle funds in the consumer marketplace while immediately generating a revenue stream and a predetermined bottom line profit depending upon the level of risk to be accepted by the bank. Moreover, the bank will not have to expend large sums of money for marketing its loans or offer costly incentives before it can find a sufficient number of consumers to whom loans can be made so as to fully absorb the idle cash maintained by the bank. By virtue of the foregoing, the bank will be able to reverse a negative amortization of its funds that has been experienced during a slow period of lending that is also marked by expensive advertising.

For this service, the intermediary will charge the lender bank a fee. Of course, the potential lender can decline to accept any investment vehicle that is presented to it by the intermediary should the vehicle not fit the investment strategy of the lender bank or should the bank choose to diversify its investment portfolio in a different direction. In the alternative, and to meet its specific objectives, the potential lender bank can request to modify the bundling of consumers and/or the corresponding interest rates to be offered to the groups of consumers assembled by the intermediary. However, and as indicated above, once a willing lender is found, the consumer debtors, the bank lenders, and the intermediary will all derive benefit from the credit card interest rate exchange and reduction method.

FIG. 2 of the drawings is a block diagram to illustrate the interrelationship of the intermediary to consumer groups who hold credit card debt at a relatively high interest rate and wish to refinance their debt at a lower rate depending upon their respective credit scores and lender banks who wish to make a tiered investment in the consumer marketplace by paying off at least some of the existing credit card debt of the consumer groups and refinancing the debt at a lower interest rate.

It is preferable for the method herein disclosed to be internet based so as to facilitate a worldwide electronic investment portfolio for lender banks and an expansion of the consumer credit card market. That is, an on-line exchange will now be available for the acquisition and sale of credit related portfolios in the worldwide consumer credit marketplace. Thus, idle or excess funds can be invested on a daily basis for making purchases of customized portfolios of consumer paper that rely on the credit scores of consumer debtors who are segregated into groups according to their scores. In this manner, lenders will be better able to assess their risks and more accurately predict their rate of return.

I claim:

1. A method for reducing the interest rate paid by consumers for carrying credit card debt, said method comprising the steps of:
(a) assigning a credit rating to each of the consumers based on his credit history;
(b) paying off at least some of the existing credit card debts of the consumers; and
(c) refinancing the credit card debts of the consumers at lower interest rates which are dependent upon the respective credit ratings of the consumers.

2. The method recited in claim 1, including the additional step of finding a lender who is willing to use its investment capital in the consumer marketplace to pay off the existing credit card debts of the consumers and to refinance at least some of said debts at the lower interest rates.

3. The method recited in claim 1, wherein the credit rating assigned to each consumer is the consumer's FICO score.

4. The method recited in claim 1, including the additional step of placing the consumers into different groups having similar assigned credit ratings.

5. The method recited in claim 4, including the additional step of refinancing the credit card debts of the group of consumers having the highest credit ratings at the lowest interest rate.

6. The method recited in claim 4, including the additional step of refinancing the credit card debt of the group of consumers having the lowest credit ratings at the highest interest rate.

7. The method recited in claim 1, including the additional step of periodically repeating steps (a), (b) and (c).

8. The method recited in claim 1, wherein the step of assigning a credit rating to each consumer is performed by an intermediary,
said intermediary also finding a lender who is willing to use its investment capital to refinance the credit card debts of the consumers at the lower interest rates and then presenting the credit card debts of the consumers to the willing lender to be paid off and refinanced.

9. The method recited in claim 8, including the additional step of the intermediary charging the consumers a fee for finding the lender willing to use its investment capital to pay off and refinance the credit card debts of the consumers at the lower interest rates.

10. The method recited in claim 8, including the additional step of the intermediary charging the lender a fee for presenting to the lender the credit card debts of the consumers for which the lender's investment capital is used to pay off and refinance said debts at the lower interest rates.
